(19) United States
(12) Patent Application Publication
(10) Pub. No.: US 2018/0191454 A1
(43) Pub. Date: Jul. 5, 2018

(54) RADIO NETWORK NODE, WIRELESS DEVICE AND METHODS PERFORMED THEREIN

(71) Applicant: TELEFONAKTIEBOLAGET LM ERICSSON (PUBL), Stockholm (SE)

(72) Inventors: Johan FURUSKOG, Stockholm (SE); Håkan ANDERSSON, Linköping (SE); Mattias FRENNE, Uppsala (SE); Johan KÅREDAL, Lund (SE); Niclas WIBERG, Linköping (SE); Qiang ZHANG, Täby (SE)

(73) Assignee: TELEFONAKTIEBOLAGET LM ERICSSON (PUBL), Stockholm (SE)

(21) Appl. No.: 15/527,212

(22) PCT Filed: Mar. 27, 2017
(86) PCT No.: PCT/SE2017/050289

§ 371 Date: May 16, 2017

Related U.S. Application Data
(60) Provisional application No. 62/322,832, filed on Apr. 15, 2016.

(51) Int. Cl. H04J 11/00; H04L 5/00; H04W 88/06

(52) U.S. Cl. CPC H04J 11/0086; H04L 5/0094; H04L 5/0053; H04W 72/042; H04J 11/0079; H04L 5/0007; H04W 88/06

(57) ABSTRACT

A method performed by a wireless device, for processing a control channel from a radio network node, is provided. The wireless device and the radio network node operate in a wireless communications network. The method comprises:
Monitoring (501) one or multiple search spaces in the control channel from a radio network node 110, which search space comprises candidates, which candidates relate to control channel message candidates that the wireless device will try to decode.
Decoding (502) in a priority order any one or more out of:
   (1) The candidates within a search space out of the one or multiple search spaces, e.g. according to embodiment 1 as described in the detailed description below and
   (2) the candidates within multiple search spaces, e.g. according to embodiment 2 as described in the detailed description below.

### TECHNICAL FIELD

Embodiments herein relate to a radio network node, a wireless device and methods performed therein. In particular, embodiments herein relates to assigning and processing a control channel in a wireless communication network.

### BACKGROUND

In a typical wireless communication network, wireless devices, also known as wireless communication devices, mobile stations, stations (STA) and/or user equipments (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a “NodeB” or “eNodeB”. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

A UE, also referred to as a wireless device, is instructed to receive and process a transmission over a data channel by first receiving and processing a control information message conveyed over a downlink control channel from a radio network node in a wireless communications network.

The UE continuously monitors the control channel by blindly decoding a set of candidates. A candidate is a hypothetical transmission of a control information message on the control channel that the UE attempts to decode, regardless if there is an actual transmission or not. When a radio network node addresses a UE it performs an actual transmission using a candidate that the UE monitors. If the UE successfully decodes a candidate it will process the message content and act accordingly. The message content may e.g., be a downlink assignment that comprises all information needed by the UE to receive and process an associated downlink data transmission, or an uplink grant comprising all information needed by UE to process and transmit an associated uplink data transmission.

The set of candidates that the UE monitors within a certain time interval is referred to as a search space and the candidates it comprises may be given as a function of time and UE identity.

A UE may have multiple simultaneous search spaces to monitor, e.g., a common search space that is shared by all served UEs within the service area that can be used for assigning transmissions of system information, and a dedicated or UE-specific search space that can be used for assigning dedicated transmissions such as user data. The LTE standard also defines a control channel where a UE may have two UE-specific search spaces that can be utilized for different purposes, such as multi-point transmission.

A control channel may either be frequency multiplexed (FDM) or time multiplexed (TDM) with the data channel, as well as a mix of both as can be seen in the example of FIG. 1

Control channel elements are mapped to physical resources in a predefined manner as illustrated in FIG. 2a

The search space is a set of candidates formed by one or several control channel elements as illustrated in FIG. 2b.

The context below relates to LTE so the exact terminology, such as PDCCH and the different RNTIs, may use another terminology in future standards. A UE searches for Downlink Control Information (DCI)s intended for it and the UE searches for possible resource allocations in a related search space.

A search space indicates a set of Control Channel Element (CCE) locations, also referred to as the candidates, where the UE may find its Physical Downlink Control Channel (PDCCH)s. Each PDCCH carries one DCI and is identified by a Radio Network Temporary ID, (RNTI). There are two types of search space: the common search space and the UE-specific search space. A UE is required to monitor both common and UE-specific search space. There may be overlap between common and UE-specific search spaces for a UE.

The common search space comprises the DC's for system information. The UE-specific search space may carry DC's for UE-specific allocations e.g. using the UE's assigned C-RNTI, Semi-Persistent Scheduling (SPS C-RNTI), or initial allocation (temporary C-RNTI).

After each blind detection, the UE checks the CRC with the corresponding RNTI. If CRC succeeds, the UE can derive the exact DCI format of the detected PDCCH from the payload size and RNTI. Knowing the DCI format, the UE can go ahead and parse the payload.

### SUMMARY

An object herein is to provide a mechanism that handles a control channel such that that the performance of a wireless communication network is improved.

According to a first aspect the object is achieved by example embodiments of a method performed by a wireless device, for processing a control channel from a radio network node.

The wireless device and the radio network node operate in a wireless communications network. The method comprises:
Monitoring one or multiple search spaces in the control channel from a radio network node, which search space comprises candidates, which candidates relate to control channel message candidates that the wireless device will try to decode.

The method further comprises:
Decoding in a priority order any one or more out of:
   (1) The candidates within a search space out of the one or multiple search spaces, e.g. according to embodiment 1 as described in the detailed description below and
   (2) the candidates within multiple search spaces, e.g. according to embodiment 2 as described in the detailed description below.

According to a second aspect the object is achieved by example embodiments of a method performed by a radio network node, for assigning a control channel to a wireless terminal.

The wireless device and the radio network node operate in a wireless communications network. The method comprises:
Creating one or multiple search spaces in the control channel to the wireless terminal, which search space comprises candidates, which candidates relate to control channel message candidates that the wireless device will try to decode, which creating is performed by assigning in a priority order any one or more out of:
   (1) The candidates within a search space out of the one or multiple search spaces, e.g. according to embodiment 1 as described in the detailed description below and
   (2) the candidates within multiple search spaces, e.g. according to embodiment 2 as described in the detailed description below.

Sending the one or multiple search spaces in the control channel to the wireless terminal.

According to a third aspect the object is achieved by example embodiments of a wireless device for processing a control channel from a radio network node. The wireless device and the radio network node are operable in a wireless communications network.

The wireless device is configured to monitor one or multiple search spaces in the control channel from a radio network node, which search space comprises candidates, which candidates relate to control channel message candidates that the wireless device 120 will try to decode.

The wireless device is further configured to decode in a priority order any one or more out of:
(1) The candidates within a search space out of the one or multiple search spaces, e.g. according to embodiment 1 as described in the detailed description below, and
(2) the candidates within multiple search spaces, e.g. according to embodiment 2 as described in the detailed description below.

According to a forth aspect the object is achieved by example embodiments of a radio network node for assigning a control channel to a wireless terminal.

The wireless device and the radio network node are operable in a wireless communications network.

The radio network node is configured to create one or multiple search spaces in the control channel to the wireless terminal, which search space is arranged to comprise candidates, and which candidates relate to control channel message candidates that the wireless device will try to decode. The radio network node is configured to perform the creating by assigning in a priority order any one or more out of:
(1) The candidates within a search space out of the one or multiple search spaces, e.g. according to embodiment 1 as described in the detailed description below, and
(2) the candidates within multiple search spaces, e.g. according to embodiment 2 as described in the detailed description below.

The radio network node is configured to send the one or multiple search spaces in the control channel to the wireless terminal.

By assigning the multiple search spaces or the candidates within a search space in a priority order, latency-critical control information can be conveyed in candidates with the highest priority, resulting in that they will be decoded first by the wireless device.

In this way the handling of the control channel results in that the performance of a wireless communication network is improved.

### BRIEF DESCRIPTION OF THE DRAWINGS

Embodiments will now be described in more detail in relation to the enclosed drawings, in which:

FIG. 1 is a schematic block diagram depicting a control channel in a wireless communications network according to prior art;

FIGS. 2a and b are schematic block diagrams depicting control channels in a wireless communications network according to prior art;

FIG. 3 is a schematic block diagram depicting embodiments of a wireless communications network;

FIG. 4 is a combined flowchart and signalling scheme according to embodiments herein;

FIG. 5 is a flowchart depicting a method performed by a wireless device according to embodiments herein;

FIG. 6 is a flowchart depicting a method performed by a radio network node according to embodiments herein;

FIG. 7 is a schematic block diagram depicting a wireless device according to embodiments herein;

FIG. 8 is a schematic block diagram depicting a radio network node according to embodiments herein;

FIG. 9 is a schematic block diagram depicting an embodiment herein;

FIG. 10 is a schematic block diagram depicting an embodiment herein;

FIG. 11 is a schematic block diagram depicting an embodiment herein;

FIG. 12 is a schematic block diagram depicting an embodiment herein;

FIG. 13 is a schematic block diagram depicting an embodiment herein;

FIG. 14 is a schematic block diagram depicting an embodiment herein;

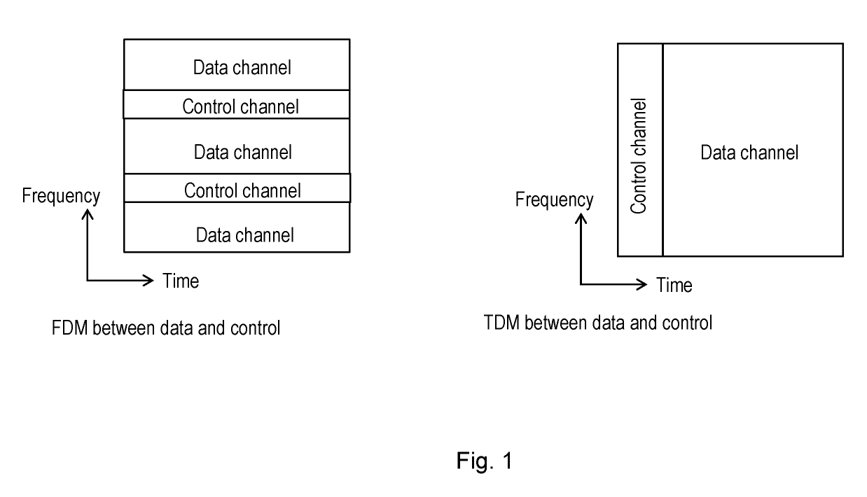

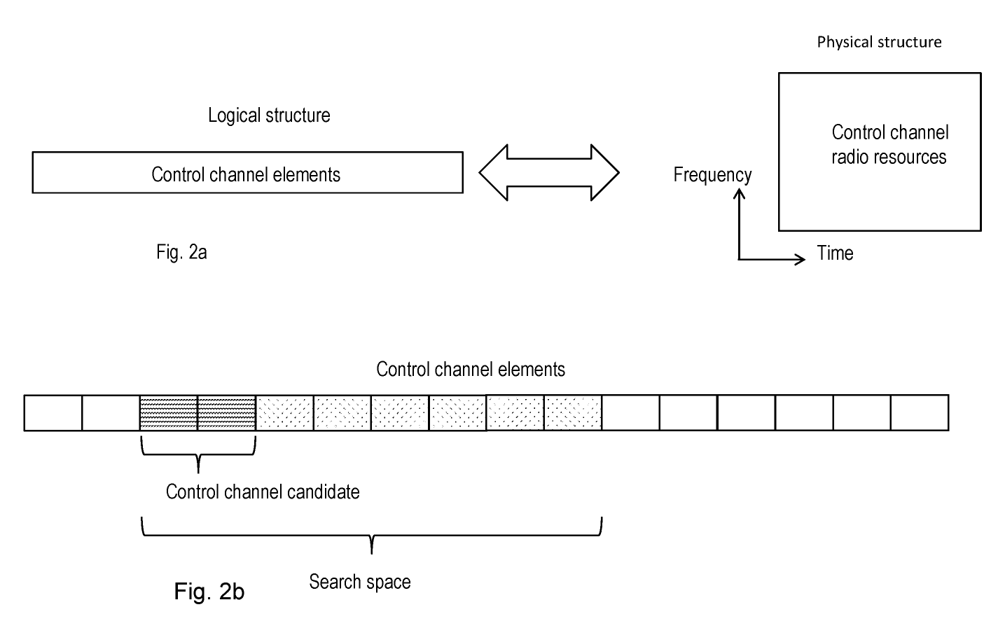

### DETAILED DESCRIPTION

The problem that embodiments herein address is that the wireless device can choose arbitrarily which order the candidates are decoded in. So the network such as the radio network node cannot know which candidate that is decoded first. If it knew it could convey latency-critical control information using a candidate the wireless device decodes first. This is solved in embodiments herein by assigning priorities to the different candidates. According to some embodiments herein, certain types of control information is associated to candidates of certain priority. Then the wireless device knows where it can expect such control information. The high-priority candidates may e.g., be mapped to radio resources early in the control region (if the control region spans multiple resources in time) and then the wireless device will know at which time it may expect a certain type of control information and the earlier it can process the control information the earlier it can start processing an associated data transmission which is better from a latency perspective.

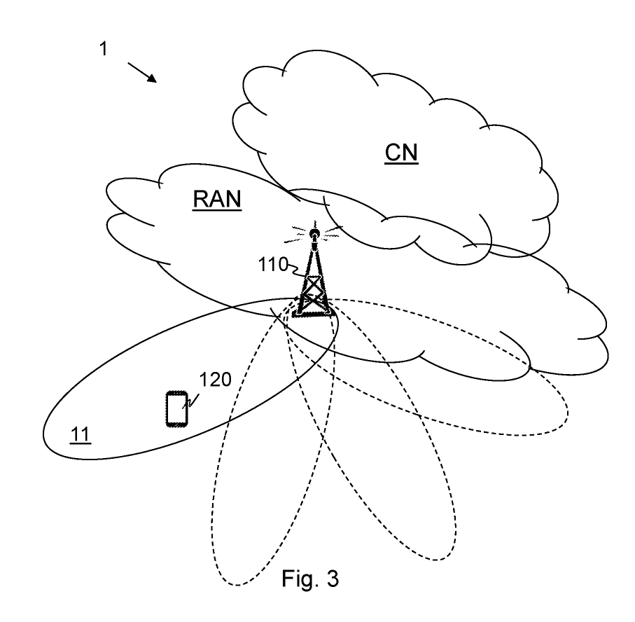

Embodiments herein relate to wireless communication networks in general. FIG. 3 is a schematic overview depicting a wireless communication network 1. The wireless communication network 1 comprises one or more RANs and one or more CNs. The wireless communication network 1 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 100, wireless devices e.g. a wireless device 120 such as a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The wireless communication network 1 comprises a radio network node 110 providing radio coverage over a geographical area, a service area 11, which may also be referred to as a beam or a beam group of a first radio access technology (RAT), such as 5G, LTE, Wi-Fi or similar. The radio network node 110 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the radio network node 110 depending e.g. on the first radio access technology and terminology used. The radio network node 110 may be referred to as a serving radio network node and communicates with the wireless device 120 with Downlink (DL) transmissions to the wireless device 10 and Uplink (UL) transmissions from the wireless device 120.

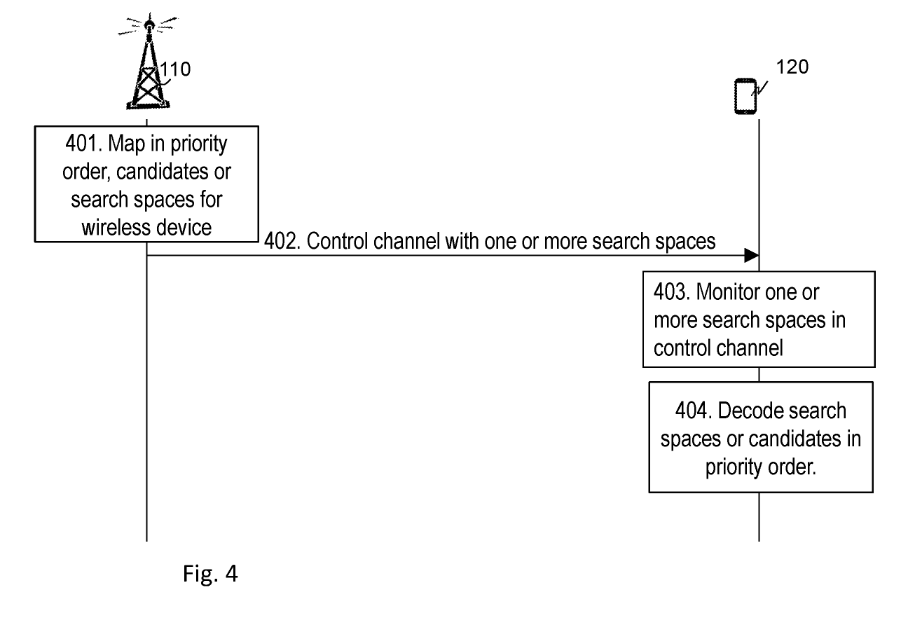

Example embodiments of a method for handling a control channel from the radio network node 110 to the wireless device 120 will now be described with reference to a sequence diagram depicted in FIG. 4. The radio network node 110 creates by assigning, or e.g. using control channel candidates or search spaces in a priority order in the control channel to the wireless terminal 120. In this example, this is performed by the radio network node 110 by mapping 401 control channel candidates or search spaces for the wireless device 120 in priority order. To map a control channel candidate or search space means that the bits corresponding to the DCI message being transmitted are allocated to the Resource Elements (REs) in the time/frequency grid that correspond to those control channel candidates or search spaces.

The radio network node 110 then sends 402 control information to the wireless terminal 120 by using the created one or multiple search spaces in the control channel.

The wireless device 120 monitors 403 the one or multiple search spaces in the control channel from the radio network node 110. The search space comprises candidates, which candidates relate to control channel message candidates that the wireless device 120 will try to decode.

The wireless device 120 decodes 404 in a priority order the candidates (1) within a search space out of the one or multiple search spaces, and/or (2) within multiple search spaces.

An advantage with the priority order is that latency-critical control information can be conveyed using the candidate or search space the wireless device 120 will decode first, i.e. with the highest priority.

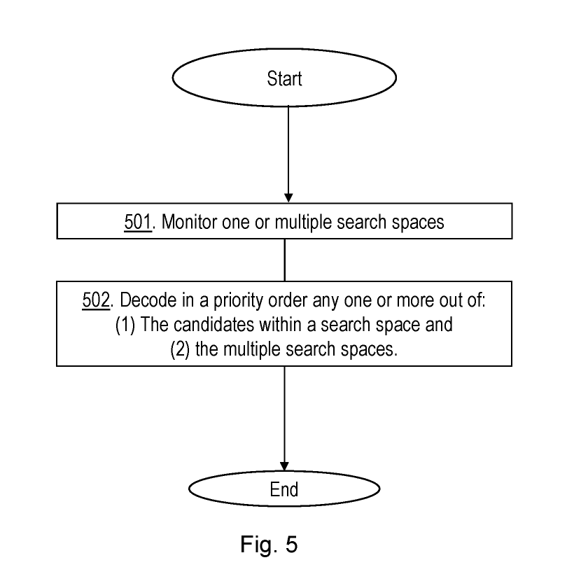

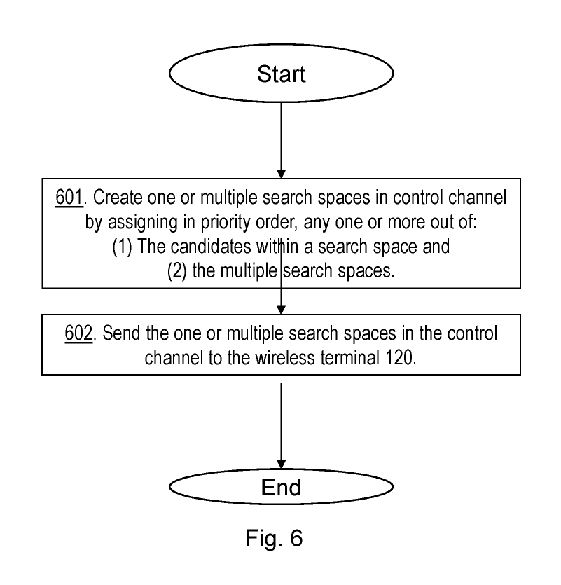

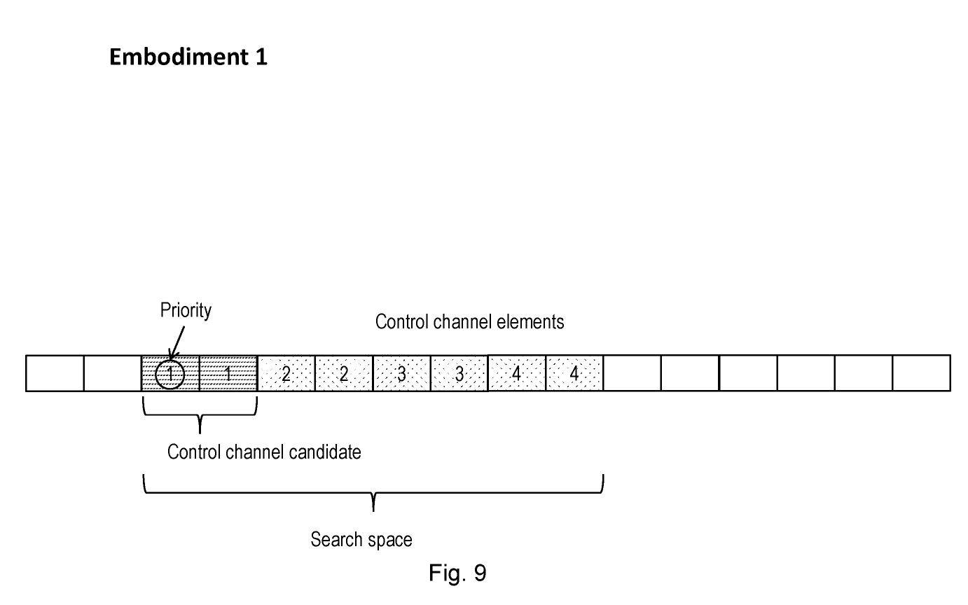

The method will first be described in a view seen from the wireless device 120 together with FIG. 5. Then the method will be described in a view seen from the radio network node 110 together with FIG. 6. A more detailed description of the different embodiments 1-7 will be described in relation to FIGS. 9-15.

FIG. 5 is a flowchart depicting a method performed by the wireless device 120. Example embodiments of a method performed by a wireless device 120 for processing a control channel from a radio network node 110 will now be described with reference to a flowchart depicted in FIG. 5.

As mentioned above, the wireless device 120 and the radio network node 110 operating in a wireless communications network 100.

The method comprises the following actions, which actions may be taken in any suitable order.

Action 501

The wireless device 120 monitors one or multiple search spaces in the control channel from the radio network node 110. The search space comprises candidates, which candidates relate to control channel message candidates that the wireless device 120 will try to decode. The candidates relating to control channel message candidates means that the candidate is a hypothetical transmission of a control information message on the control channel that the UE 120 attempts to decode, regardless if there is an actual transmission or not.

Action 502

The wireless device 120 decodes, in a priority order any one or more out of:
(1) the candidates within a search space out of the one or multiple search spaces, such as the example embodiment 1 described below, and
(2) the candidates within multiple search spaces, such as the example embodiment 2 described below.

Priority order when used herein means that candidates assigned higher priority order are decoded before candidates assigned with lower priority order.

This means that either (1) the candidates within a search space out of the one or multiple search spaces are decoded in a priority order by the wireless device 120,
or that (2) the candidates within multiple search spaces are decoded in a priority order by the wireless device 120,
or that both (1) the candidates within a search space out of the one or multiple search spaces and (2) the candidates within multiple search spaces are decoded in a priority order by the wireless device 120.

By decoding the candidates in a priority order, e.g. latency-critical control information conveyed in candidates with the highest priority, highest-priority candidates will be decoded first by the wireless device 120 followed by candidates assigned with lower priority.

In some embodiments relating to embodiment 4, wherein (2) the candidates within multiple search spaces are decoded 502 in a priority order, a search space of higher priority is assigned to earlier time resources and a search space of lower-priority is mapped to later time resources. This will be described more in detail below. To be mapped or assigned to earlier and later time resources means that the candidates of the search space are assigned to radio resources occurring in a well-defined chronological order.

In some of these embodiments 4, a high-priority search space is assigned to resources in a first OFDM symbol and the lower-priority search space is assigned to resources in a second OFDM symbol. First and second OFDM symbol only relate to first symbol being transmitted earlier in time compared to the second, not that they have to be symbols numbered one and two in, e.g. a subframe.

In some embodiments relating to embodiment 3, wherein (1) the candidates within a search space out of the one or multiple search spaces comprise candidates of higher priority being assigned to time resources earlier in the search space if the search space spans multiple time resources.

In some of these embodiments 3, a high-priority candidate is assigned to resources in a first OFDM symbol of the search space while a candidate of lower-priority may be assigned to resources in the second OFDM symbol.

This will be described more in detail below.

In some embodiments relating to embodiment 5, wherein (1) the candidates within a search space out of the one or multiple search spaces are decoded 502 in a priority order, the search space for particular DCI formats is limited. In these embodiments the DCI formats may be restricted to candidates of a certain priority. E.g. latency-critical control information may always be assigned to candidates or search spaces of high priority. Latency-critical control information may e.g. be DL assignments.

This will be described more in detail below.

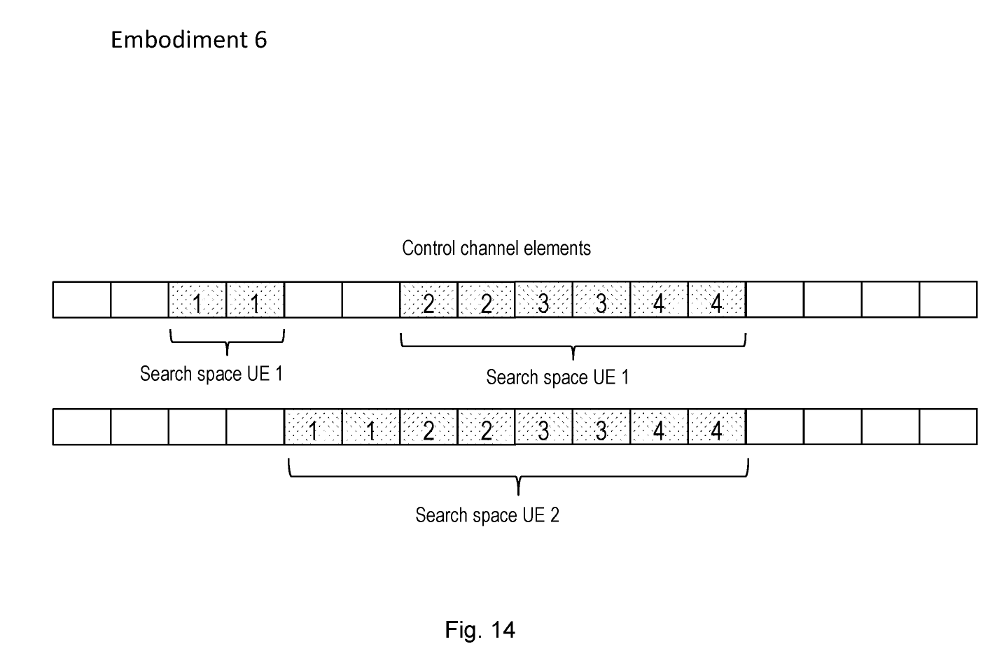

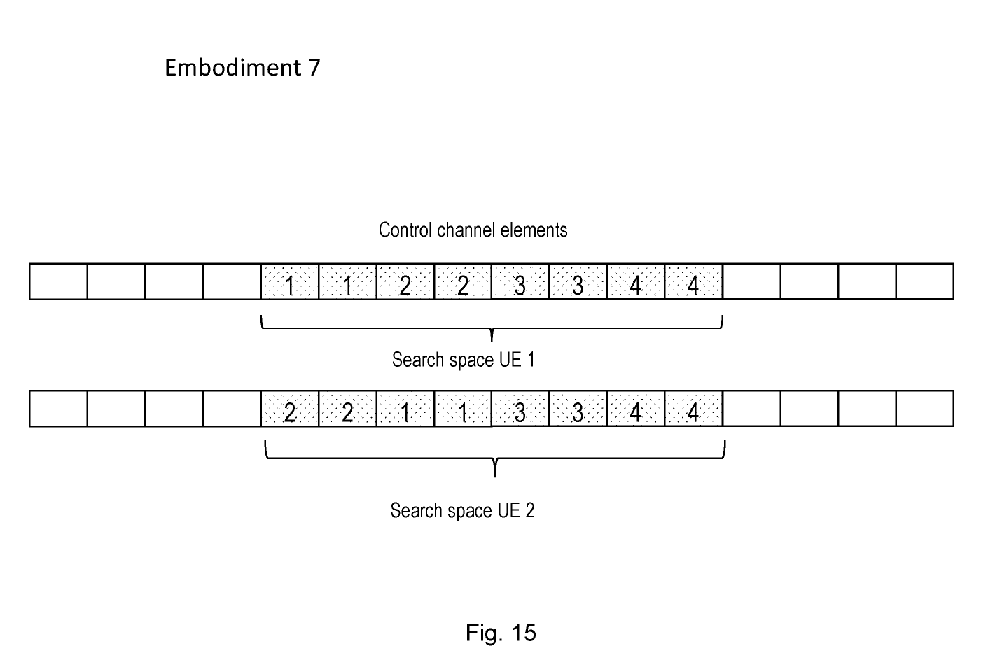

In some embodiments relating to embodiment 6, wherein (1) the candidates within a search space out of the one or multiple search spaces are decoded 502 in a priority order, and wherein high-priority candidates monitored by the wireless device 120 are assigned to not overlap in terms of radio resources such as control-channel elements with any candidates monitored by another wireless device. This may be seen from FIG. 14 and the description of embodiment 6 below. These radio resources may e.g. be referred to as (partially) overlapping control-channel elements or search spaces since these are by design possible to assign to a choice of UEs if their respective search spaces overlap. However, only one UE can use the space, but the receiving UEs don't know which one was actually granted the exclusive use of the resource. Hence, there is a need for blind decoding.

This will be described more in detail below.

In some embodiments relating to embodiment 7, wherein (1) the candidates within a search space out of the one or multiple search spaces are decoded 502 in a priority order, the high-priority candidates monitored by the wireless device 120 are assigned to not overlap in terms of radio resources such as control-channel elements with high-priority candidates monitored by another wireless device. This may be seen from FIG. 15 and the description of embodiment 7 below.

FIG. 6 is a flowchart depicting a method performed by the radio network node 110. Example embodiments of a method performed by a radio network node 110, for assigning a control channel to a wireless device 120, will now be described with reference to a flowchart depicted in FIG. 6. As mentioned above, the wireless device 120 and the radio network node 110 operating in a wireless communications network 100.

The method comprises the following actions, which actions may be taken in any suitable order.

Action 601

The radio network node 110 creates one or multiple search spaces in the control channel to the wireless terminal 120. The search space comprises candidates. The candidates relate to control channel message candidates that the wireless device 120 will try to decode.

The creating is performed by assigning in a priority order any one or more out of:
(1) the candidates within a search space out of the one or multiple search spaces, such as embodiment 1 described below, and
(2) the candidates within multiple search spaces such as embodiment 2 described below.

This means that either (1) the candidates within a search space out of the one or multiple search spaces are created by being assigned or used in a priority order by the radio network node 110,
or that (2) the candidates within multiple search spaces are created by being assigned or used in a priority order by the radio network node 110,
or that both (1) the candidates within a search space out of the one or multiple search spaces and (2) the candidates within multiple search spaces are created by being assigned or used in a priority order by the radio network node 110.

The creating may be performed by assigning certain control channel elements or search spaces to a DCI message being transmitted and subsequently mapping the bits corresponding to the DCI to the REs in the time/frequency grid that correspond to those control channel candidates or search spaces.

An example of assigning is when a latency-critical DCI message is assigned to a high-priority control channel candidate or search space and the corresponding message bits are mapped to the REs corresponding to those control channel elements or search spaces.

By creating by assigning the candidates in a priority order, e.g. latency-critical control information conveyed in candidates with the highest priority, will be decoded first by the wireless device 120 followed by candidates created with lower priority.

In some embodiments relating to embodiment 4, wherein (2) the candidates within multiple search spaces are created by being assigned or used in a priority order, a search space of higher priority is assigned to earlier time resources and a search space of lower-priority is mapped to later time resources.

This will be described more in detail below. To be mapped or assigned to time resources mean that the candidates of the search space are assigned to radio resources occurring at a certain time.

In these embodiments relating to embodiment 4, the search space of higher priority may be any one out of: assigned by the radio network node 110 and is given in a related standard specification.

In these embodiments relating to embodiment 4, a high-priority search space is assigned to resources in a first OFDM symbol and the lower-priority search space is assigned to resources in a second OFDM symbol.

The terms “first and second” OFDM symbol only relate to first symbol being transmitted earlier in time compared to the second, not that they have to be symbols numbered one and two in, e.g., a subframe.

This will be described more in detail below.

In some embodiments relating to embodiment 3, (1) the candidates within a search space out of the one or multiple search spaces comprise candidates of higher priority being assigned to time resources earlier in the search space if the search space spans multiple time resources.

In these embodiments relating to embodiment 3, a high-priority candidate may be assigned to resources in a first OFDM symbol of the search space while a candidate of lower-priority may be assigned to resources in the second OFDM symbol.

This will be described more in detail below.

In some embodiments relating to embodiment 5, wherein (1) the candidates within a search space out of the one or multiple search spaces are created by being assigned or used in a priority order, the search space for particular DCI formats is limited. In these embodiments, the DCI formats are restricted to candidates of a certain priority. E.g. latency-critical control information may always be assigned to candidates or search spaces of high priority. Latency-critical control information may e.g. be DL assignments.

In some embodiments relating to embodiment 6, wherein (1) the candidates within a search space out of the one or multiple search spaces are created by being assigned or used in a priority order, high-priority candidates monitored by the wireless device 120 are assigned to not overlap in terms of radio resources such as control-channel elements (See FIG. 14 and embodiment 6 described below) with any candidates monitored by another wireless device. This may be seen from FIG. 14 and the description of embodiment 6 below. These radio resources may e.g. be referred to as partially overlapping control-channel elements or search spaces since these are by design possible to assign to a choice of UEs if their search spaces overlap. However, only one UE can use the space, but the receiving UEs don't know which one was actually granted the exclusive use of the resource. Hence, there is a need for blind decoding.

In some embodiments relating to embodiment 7, wherein (1) the candidates within a search space out of the one or multiple search spaces are created by being assigned or used in a priority order, high-priority candidates monitored by the wireless device 120 are assigned to not overlap in terms of radio resources such as control-channel elements (See FIG. 15 and embodiment 7 described below) with high-priority candidates monitored by another wireless device.

Action 602

The radio network node 110 may then send to the wireless terminal 120, control information by using the created one or multiple search spaces in the control channel.

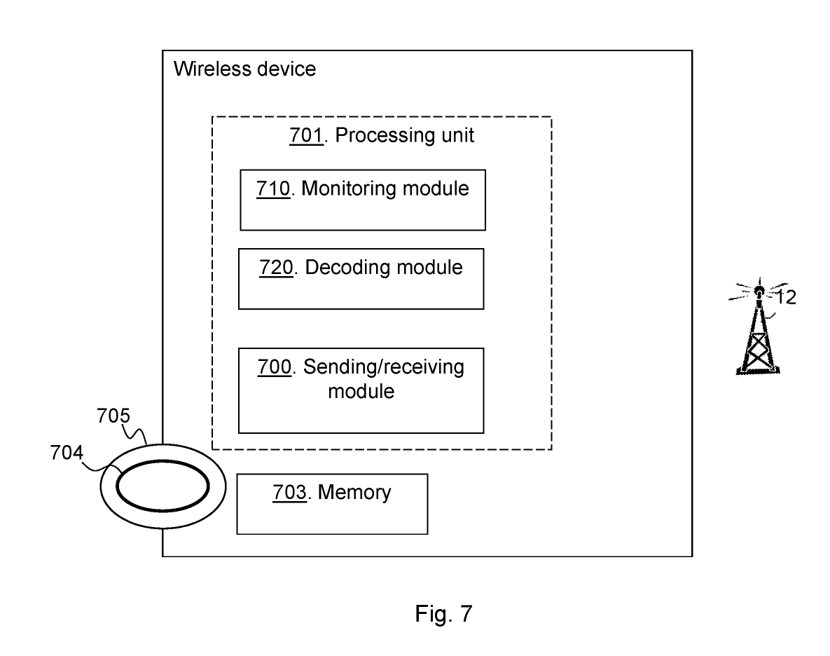

FIG. 7 is a schematic block diagram depicting the wireless device 120

To perform the method actions for processing a control channel from a radio network node 110, the wireless device 120 may comprise the following arrangement depicted in FIG. 7.

The wireless device 120 may comprise a sending/receiving module 700 configured to communicate, with one or more radio nodes such as the radio network node 110. The input and output interface 700 may comprise a receiver (not shown) and a transmitter (not shown).

The wireless device 120 and the radio network node 110 are operable in a wireless communications network 1.

The wireless device 120 is configured to, e.g. by means of a monitoring module 710 configured to, monitor one or multiple search spaces in the control channel from a radio network node 110, which search space comprises candidates, which candidates relate to control channel message candidates that the wireless device 120 will try to decode.

The wireless device 120 is further configured to, e.g. by means of a decoding module 720 configured to decode in a priority order any one or more out of:
(1) The candidates within a search space out of the one or multiple search spaces, e.g. according to embodiment 1 as described in the detailed description below, and
(2) candidates within multiple search spaces, e.g. according to embodiment 2 as described in the detailed description below.

(1) Candidates within a Search Space

In some embodiments, e.g. according to embodiment 3 as described in the detailed description below, candidates of higher priority are arranged to be assigned to time resources earlier in the search space if the search space spans multiple time resources.

For example a high-priority candidate may be arranged to be assigned to resources in the first OFDM symbol of the search space while a candidate of lower priority may be arranged to be assigned to resources in the second OFDM symbol.

In some embodiments, e.g. according to embodiment 5 as described in the detailed description below, the search space may be arranged to be limited. The wireless device 120 may be configured to assume that particular DCI formats are restricted to candidates of a certain priority, such e.g., latency-critical control information may be arranged to always be assigned to candidates or search spaces of high priority. Latency-critical control information may e.g., be DL assignments.

In some embodiments, e.g. according to embodiment 6 as described in the detailed description below, high-priority candidates arranged to be monitored by the wireless device 120 are arranged to be assigned to not overlap in terms of radio resources such as control-channel elements as can be seen from FIG. 14 and embodiment 6 described above, with any candidates arranged to be monitored by another wireless device.

In some embodiments, e.g. according to embodiment 7 as described in the detailed description below, high-priority candidates arranged to be monitored by the wireless device 120 are arranged to be assigned to not overlap in terms of radio resources such as control-channel elements as can be seen from FIG. 15 and embodiment 7 described above, with high-priority candidates arranged to be monitored by another wireless device.

(2) Candidates within Multiple Search Spaces

In some embodiments, e.g. according to embodiment 4 as described in the detailed description below, a search space of higher priority is arranged to be assigned to earlier time resources and a search space of lower-priority is arranged to be mapped to later time resources. The terms mapped or assigned to time resources means that the candidates of the search space are assigned to radio resources occurring at a certain time.

E.g., a high-priority search space is arranged to be assigned to resources in the first OFDM symbol and the lower-priority search space is arranged to be assigned to resources in the second OFDM symbol.

The embodiments herein may be implemented through one or more processors, such as a processing unit 701 in the wireless device 120 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise a memory 703 comprising one or more memory units. The memory 703 comprises instructions executable by the processing unit 701. The memory 703 is arranged to be used to store e.g. assignments, priority orders, information, data, configurations, etc. to perform the methods herein when being executed in the wireless device 120.

In some embodiments, a computer program 704 comprises instructions, which when executed by the at least one processor such as the processing unit 701, cause the at least one processing unit 701 to perform actions according to any of the Actions 501-502.

In some embodiments, a carrier 705 comprises the computer program 704, wherein the carrier is one of an electronic signal, an optical signal, an electromagnetic signal, a magnetic signal, an electric signal, a radio signal, a microwave signal, or a computer-readable storage medium.

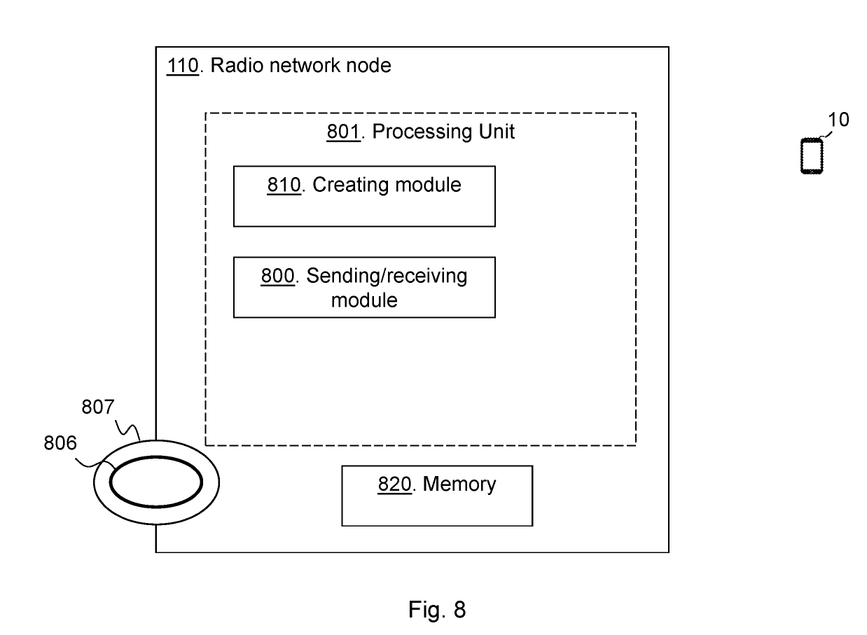

FIG. 8 is a schematic block diagram depicting the radio network node 110.

To perform the method actions for creating by assigning a control channel to a wireless terminal 120, the radio network node 110 may comprise the following arrangement depicted in FIG. 8.

The radio network node 110 may comprise a sending/receiving module 800 configured to communicate, with one or more wireless devices such as the wireless device 120. The input and output interface 800 may comprise a receiver (not shown) and a transmitter (not shown).

The wireless device 120 and the radio network node 110 are operable in a wireless communications network 100.

The radio network node 110 is configured to, e.g. by means of a creating module 810 configured to, create one or multiple search spaces in the control channel to the wireless terminal 120, which search space is arranged to comprise candidates, and which candidates relate to control channel message candidates that the wireless device 120 will try to decode. The radio network node 110 is configured to perform the creating by assigning in a priority order any one or more out of:
(1) The candidates within a search space out of the one or multiple search spaces, e.g. according to embodiment 1 as described in the detailed description below, and
(2) the candidates within multiple search spaces, e.g. according to embodiment 2 as described in the detailed description below.

The radio network node 110 is configured to, e.g. by means of a sending module 800 configured to, send the one or multiple search spaces in the control channel to the wireless terminal 120.

(1) Candidates within a Search Space

In some embodiments, e.g. according to embodiment 3 as described in the detailed description below, the radio network node 110 is configured to perform the creating by assigning candidates of higher priority to time resources earlier in the search space if the search space spans multiple time resources.

For example the radio network node 110 may be configured to perform the creating by assigning a high-priority candidate to resources in the first OFDM symbol of the search space while a candidate of lower-priority is assigned to resources in the second OFDM symbol.

In some embodiments, e.g. according to embodiment 5 as described in the detailed description below, the search space may be limited. The radio network node 110 is configured to perform the creating by assigning such that particular DCI formats are restricted to candidates of a certain priority. E.g. such latency-critical control information may always be configured to be assigned to candidates or search spaces of high priority. Latency-critical control information may e.g. be DL assignments.

In some embodiments, e.g. according to embodiment 6 as described in the detailed description below, the radio network node 110 is configured to perform the creating by assigning high-priority candidates to be monitored by the wireless device 120 to not overlap in terms of radio resources such as control-channel elements as can be seen from FIG. 14 and embodiment 6 described above, with any candidates to be monitored by another wireless device.

In some embodiments, e.g. according to embodiment 7 as described in the detailed description below, the radio network node 110 is configured to perform the creating by assigning high-priority candidates to be monitored by the wireless device 120 to not overlap in terms of radio resources such as control-channel elements as can be seen from FIG. 15 and embodiment 7 described above, with high-priority candidates to be monitored by another wireless device.

(2) Candidates within Multiple Search Spaces

In some embodiments, e.g. according to embodiment 4 as described in the detailed description below, the radio network node 110 is configured to perform the creating by assigning a search space of higher priority to earlier time resources and a search space of lower-priority to later time resources. The term mapped or assigned to time resources means that the candidates of the search space are assigned to radio resources occurring at a certain time.

E.g., the radio network node 110 may be configured to perform the creating by assigning a high-priority search space to resources in the first OFDM symbol and the lower-priority search space is assigned to resources in the second OFDM symbol.

The embodiments herein may be implemented through one or more processors, such as a processing unit 801 in the radio network node 110 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as a memory stick. The computer program code may furthermore be provided as pure program code on a server and downloaded to the radio network node 110.

The radio network node 110 may further comprise a memory 820 comprising one or more memory units. The memory 605 comprises instructions executable by the processing unit 801. The memory 820 is arranged to be used to store e.g. assignments, priority orders, information, data, configurations, etc. to perform the methods herein when being executed in the radio network node 110.

In some embodiments, a computer program 806 comprises instructions, which when executed by the at least one processor such as the processing unit 801, cause the at least one processing unit 801 to perform actions according to Action 601.

In some embodiments, a carrier 807 comprises the computer program 806, wherein the carrier is one of an electronic signal, an optical signal, an electromagnetic signal, a magnetic signal, an electric signal, a radio signal, a microwave signal, or a computer-readable storage medium.

By assigning the multiple search spaces or the candidates within a search space in a priority order, latency-critical control information can be conveyed in candidates with the highest priority, resulting in that they will be decoded first by the wireless device 120.

In this way the handling of the control channel results in that the performance of a wireless communication network is improved.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

Embodiments herein relate to priority order of decoding search spaces or candidates in a search space. The candidates relate to control channel message candidates that the wireless device 120 shall try to decode.

The radio network node 110 may perform the assigning of the priority order and the wireless device 120 may be configured to know the priority order or may receive information about the priority order from the radio network node 110.

In some embodiments the wireless device 120 receives a configuration of the priority order from the radio network node 110, in another embodiment the assigning of the priority order is given in the standard specification.

The following example embodiments may be used individually or may be combined in a suitable way.

The wordings “tries to decode” and “decodes” are used interchangeable herein.

The wordings “candidates” and “control channel candidates”, are used interchangeable herein and relate to control channel message candidates that the wireless device 120 will try to decode.

According to example Embodiment 1, the wireless device 120 decodes the candidates within a search space in a specified priority order, see the example depicted in FIG. 9. In this example, the search space comprises eight control channel elements, i.e. four control channel candidates comprising two control channel elements each. A candidate may comprise more or less control channel elements but this is not depicted in this example. The left-most control channel candidate illustrated with horizontal stripes in FIG. 9, have priority one referred to as 1 in FIG. 9, and shall be decoded first by the wireless device 120, followed in turn by the control channel candidates to the right illustrated with dots in FIG. 9 which are the control channel candidate with priority 2, then control channel candidate with priority 3, then finally control channel candidate with priority 4.

An advantage with this embodiment is that latency-critical control information can be conveyed using the candidate the wireless device 120 will decode first, i.e. with the highest priority as in this example is the priority 1 control channel candidate.

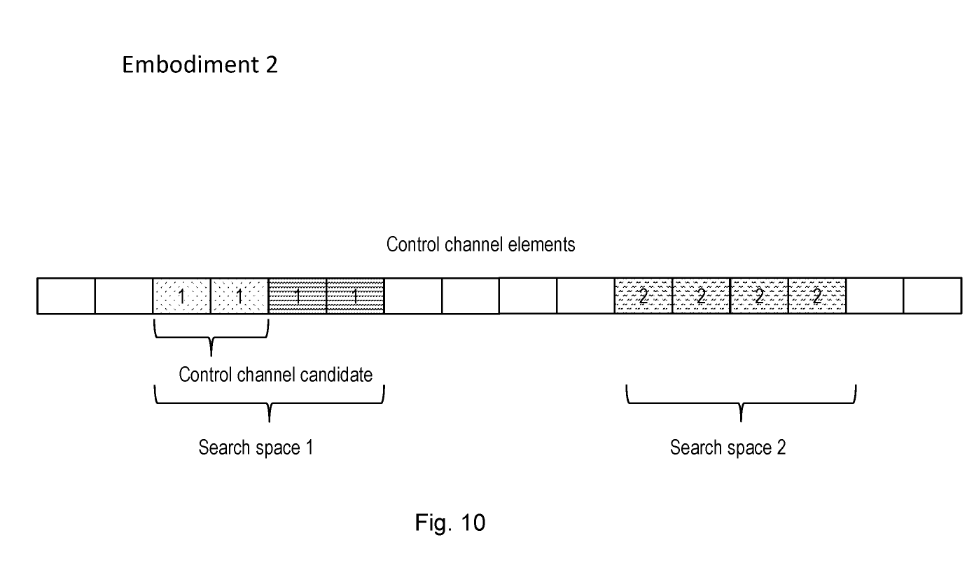

According to example Embodiment 2, the wireless device 120 monitors multiple search spaces, and decodes the search spaces in a specified priority order, see the example depicted in FIG. 10. In this example, the wireless device 120 monitors two search spaces, the left-most search space referred to as Search space 1 in FIG. 10, comprises four control channel elements, i.e. two control channel candidates assuming that a candidate comprises two control channel elements in this example. The right-most search space referred to as Search space 2 in FIG. 10, also comprises four control channel elements, i.e. two control channel candidates. Whereof the left-most search space, Search space 1, has priority one, and shall be decoded first by the wireless device 120, followed in turn by the right-most search space, Search space 1, with priority 2.

An advantage with this embodiment is that latency-critical control information may be conveyed using the search space the wireless device 120 will decode first, i.e. with the highest priority as in this example is the priority 1 search space, the left-most search space in FIG. 10.

The two left-most control channel elements of Search space 1 with priority 1 illustrated with dots in FIG. 10 constitute one control channel candidate.

The two-right most control channel elements of Search space 1 also with priority 1 illustrated with stripes in FIG. 10 constitute a second control channel candidate.

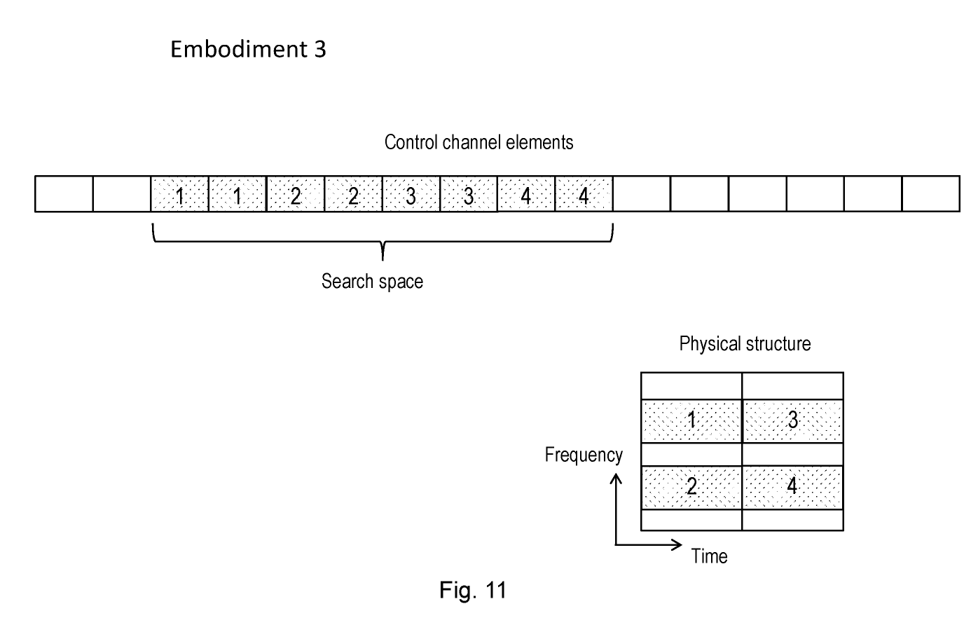

According to example Embodiment 3, control channel candidates of higher priority are mapped to time resources earlier in the search space if the search space spans multiple time resources, see the example depicted in FIG. 11. E.g., a high-priority control channel candidate may be mapped to resources in the first OFDM symbol of the search space while a candidate of lower-priority is mapped to resources in the second OFDM symbol.

In the example of FIG. 11, the wireless device 120 monitors a search space comprising eight control channel elements, i.e. four control channel candidates illustrated with dots in FIG. 11, assuming that a candidate consists of two control channel elements, whereof the control channel candidates of higher priority are mapped to time resources referred to as 1 and 2 in FIG. 11 and will be decoded first by the wireless device 120. Thus the wireless device 120 will decode the dotted control candidates in priority order, starting with dotted control candidate 1, followed by in turn, the dotted control candidate 2, the dotted control candidate 3 and finally the dotted control candidate 4, which can be seen in FIG. 11.

An advantage with this embodiment is that the high-priority candidates may be transmitted earlier than the low priority candidates in the search space, and may thus be decoded earlier by the wireless device 120.

Further in FIG. 11, the Physical structure of the time/frequency grid found in an OFDM-based system is depicted. The transmission is performed symbol-by-symbol, meaning that the first OFDM-symbol to be transmitted constitutes the REs that span the entire frequency bandwidth and the time duration containing the control channel elements denoted 1 and 2. Similarly, the second OFDM-symbol contains the control channel elements denoted 3 and 4.

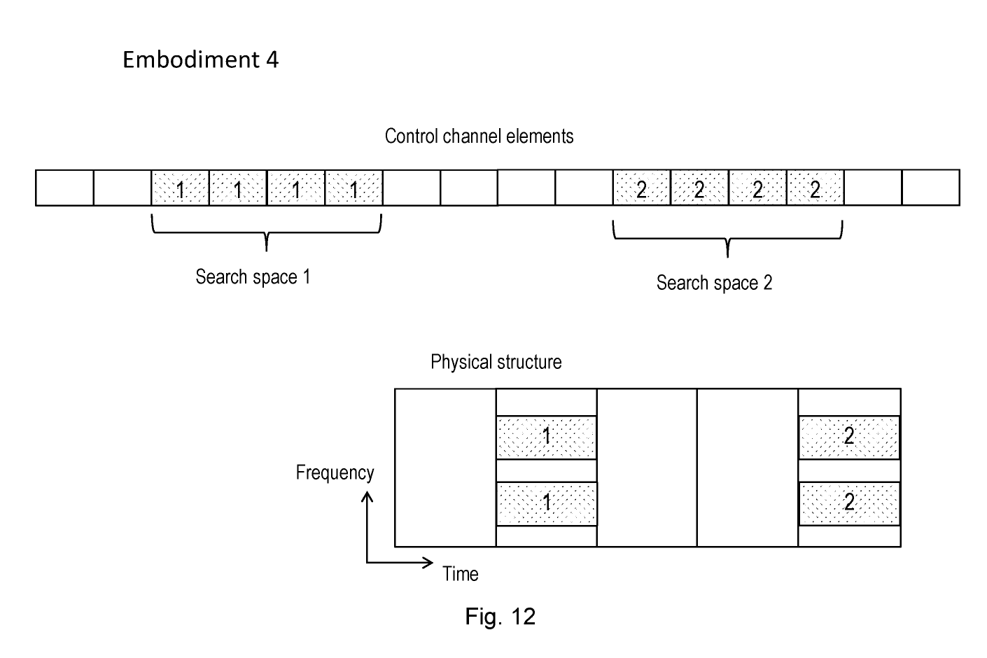

According to example Embodiment 4, a search space of higher priority is mapped to earlier time resources and a search space of lower-priority is mapped to later time resources, see the example depicted in FIG. 12. E.g., a high-priority search space is mapped to resources in the first OFDM symbol and the lower-priority search space is mapped to resources in the second OFDM symbol. As mentioned above, the terms “first and second” OFDM symbol only relate to first symbol being transmitted earlier in time compared to the second, not that they have to be symbols numbered one and two in, e.g., a subframe. This can be seen from FIG. 12, where the first OFDM symbol with the search space denoted 1 is mapped as the second OFDM symbol in the illustrated transmission, and the second OFDM symbol with the search space denoted 2 is mapped as the fifth OFDM symbol in the illustrated transmission. Note, however, that an implementation may be that the “first” and “second” indeed refer to the first and second OFDM symbols in a transmission interval. The control candidates depicted in FIG. 12 are illustrated with dots. In the example of FIG. 12, the wireless device 120 monitors two search spaces, the left-most search space referred to as Search space 1 in FIG. 12, comprises four control channel elements, and the right-most search space, referred to as Search space 2 in FIG. 12, also comprises four control channel elements. As can be seen from FIG. 12, the left-most search space has priority one, referred to as 1 in FIG. 12, and shall be decoded first by the wireless device 120, followed in turn by the right-most search space with priority 2.

An advantage with this embodiment is that the control channel candidates in the high-priority search space can be transmitted earlier than candidates in the low priority search space and may thus be decoded earlier by the wireless device 120.

The number of CCEs the control channel candidate comprises depends on the Aggregation Level (AL). In the examples above AL=2 is chosen, i.e., two CCEs per candidate. The wireless device 120 monitors multiple aggregation levels, e.g., AL=1, 2 and 4. If it has 8 control channel elements in a search space it results in 8 AL=1 candidates, 4 AL=2 candidates and 2 AL=4 candidates. The higher aggregation level the more physical radio resources are used, which lowers the code rate and increases the robustness.

Further in FIG. 12, the Physical structure of a time/frequency grid found in an OFDM-based system is depicted. The transmission is performed symbol-by-symbol, meaning that the first OFDM-symbol to be transmitted constitutes the REs that span the entire frequency bandwidth and the time duration marked by the first rectangle from the left. Similarly, the second OFDM-symbol encompasses the entire frequency bandwidth and the time duration marked by the next rectangle when moving in the direction of time marked by the arrow in the figure. In the example depicted, the second OFDM symbol comprises the control channel elements associated with search space 1. This search space utilizes part of the frequency band, which is marked by dotted rectangles.

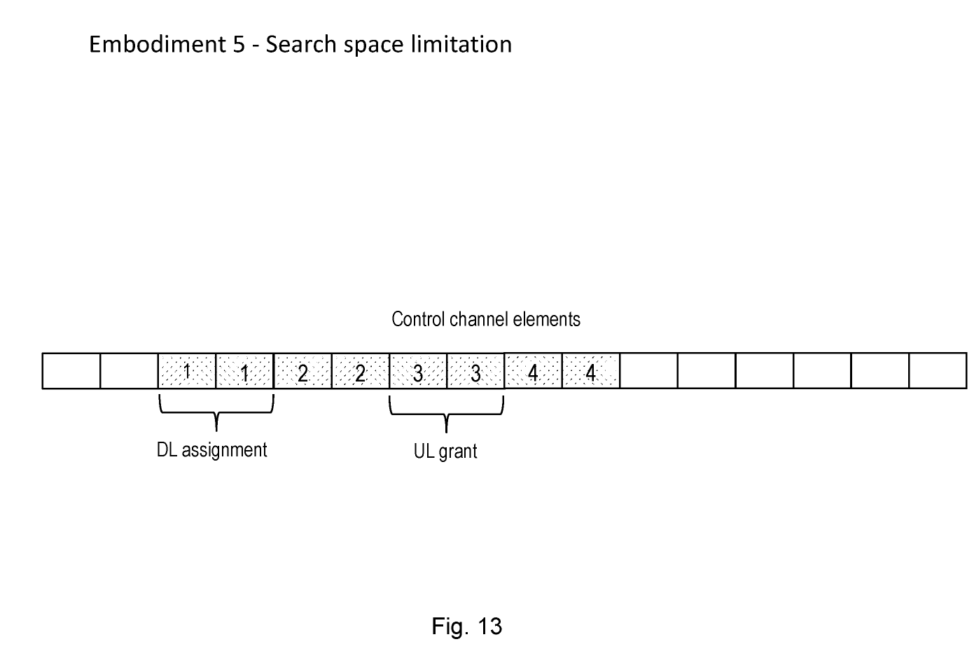

According to example Embodiment 5 relating to search space limitation, the wireless device 120 may assume that particular DCI formats are restricted to candidates of a certain priority, see the example depicted in FIG. 13. This restriction may be configured by the network or given in a standard specification. Those particular DCI formats are monitored, i.e., the UE such as the wireless device 120 will try to decode them, only using the candidates they are restricted to. The control candidates depicted in FIG. 13 are illustrated with dots.

E.g., the latency-critical control information may preferably always be mapped to candidates or search spaces of high priority. The latency-critical control information may e.g., be DL assignments, however, it may e.g. be DCI formats associated with a latency-critical service as well.

In the example of FIG. 13, a DL assignment is mapped to the left-most control channel elements, constituting a control channel candidate of higher priority, the higher priority referred to as 1 in FIG. 13 while the less latency-critical control information, e.g. an UL grant, is mapped to the control channel elements, constituting a control channel candidate of lower-priority than the high-priority candidate, the lower-priority referred to as 3 in FIG. 13.

An advantage with this embodiment is that the wireless device 120 is capable of a shorter Hybrid Automatic Repeat Request (HARQ) feedback delay for transmissions scheduled with the particular DCI formats.

According to example Embodiment 6, see the example depicted in FIG. 14, high-priority control channel candidates referred to as 1 in Search space UE 1, monitored by the wireless device 120, referred to as UE 1 in FIG. 14, are mapped such that they do not overlap in terms of radio resources such as control-channel elements with any control channel candidates, referred to as 1, 2, 3, 4 in Search space UE 2, monitored by another wireless device referred to as UE 2 in FIG. 14. As mentioned above, these radio resources may e.g. be referred to as (partially) overlapping control-channel elements or search spaces since these are by design possible to assign to a choice of UEs if their search spaces overlap. However, only one UE can use the space, but the receiving UEs don't know which one was actually granted the exclusive use of the resource. Hence, there is a need for blind decoding.

The control candidates depicted in FIG. 14 are illustrated with dots. The upper control channel elements relate to UE1 and the lower control channel elements relate to UE2 in FIG. 14.

In the example of FIG. 14, high-priority control channel candidates for UE 1 are mapped at the dotted control channel elements marked with the number 1 in the upper part of the figure. These are control channel elements 3 and 4 when counted from left. High-priority control channel candidates for UE 2 are mapped at dotted control channel elements marked with the number 1 in the lower part of the figure. These are control channel elements 5 and 6 when counted from left. This results in that the high-priority control channel candidates for UE 1 do not collide in time with any of the control channel candidates for UE 2.

An advantage with this embodiment is that scheduling restrictions due to resource conflicts are avoided, enabling shorter latency for latency-critical services.

According to example Embodiment 7, see the example depicted in FIG. 15, high-priority control channel candidates, referred to as 1 in Search space UE 1, monitored by the wireless device 120, referred to as UE 1 in FIG. 15, do not overlap in terms of radio resources with control channel candidates, referred to as 1 in Search space UE 2, monitored by another wireless device referred to as UE 2 in FIG. 15.

The control channel candidates depicted in FIG. 15 are illustrated with dots. The upper control channel elements relate to UE1 and the lower control channel elements relate to UE2 in FIG. 15. In the example of FIG. 15, high-priority control channel candidates for UE 1 are mapped at dotted control channel elements marked with number 1 and appearing at positions 5 and 6 when counted from left, referred to as 1 in Search space UE 1, and high-priority control channel candidates for UE 2 are mapped at dotted control channel elements marked with number 1 and appearing at position 7 and 8 when counted from left, referred to as 1 in Search space UE 2. This results in that the high-priority control channel candidates for UE 1 and the high-priority control channel candidates for UE 2 do not collide in time.

An advantage with this embodiment is similar to embodiment 6, but with better control channel resource utilization albeit with a potential conflict between a high- and low-priority control channel candidate.

In some embodiments, priorities are assigned to control channel elements directly, and the priority of each candidate is given by the highest priority among the control channel elements it comprises. A control channel candidate may comprise multiple control channel elements, depending on the aggregation level. So these embodiments makes sense in case of AL>=2, i.e., two or more control channel elements per control channel message. Otherwise it is just a one-to-one mapping. In the embodiment the priority is assigned on a control channel element basis, instead of a candidate basis as was the case in previous embodiments. The priority of a candidate is then given by the priority of the control channel elements it comprises. Otherwise it's the same as in the other embodiments.

According to a first aspect the object is achieved by example embodiments of a method performed by a wireless device 120, for processing a control channel from a radio network node 110. See FIGS. 3, 4, and 5.

The wireless device 120 and the radio network node 110 operate in a wireless communications network 100. The method comprises:
Monitoring 501 one or multiple search spaces in the control channel from a radio network node 110, which search space comprises candidates, which candidates relate to control channel message candidates that the wireless device 120 will try to decode.

The method further comprises:
Decoding 502 in a priority order any one or more out of:
   (1) The candidates within a search space out of the one or multiple search spaces, e.g. according to embodiment 1 as described in the detailed description below and
   (2) the candidates within multiple search spaces, e.g. according to embodiment 2 as described in the detailed description below.
      (1) and (2) are further described below:

(1) Candidates within a Search Space

In some embodiments, e.g. according to embodiment 3 as described in the detailed description below, candidates of higher priority are assigned to time resources earlier in the search space if the search space spans multiple time resources.

For example a high-priority candidate may be assigned to resources in the first OFDM symbol of the search space while a candidate of lower-priority may be assigned to resources in the second OFDM symbol.

In some embodiments, e.g. according to embodiment 5 as described in the detailed description below, the search space for particular DCI formats may be limited. The wireless device 120 may assume that these DCI formats are restricted to candidates of a certain priority, such e.g., latency-critical control information may always be assigned to candidates or search spaces of high priority. Latency-critical control information may e.g., be DL assignments.

In some embodiments, e.g. according to embodiment 6 as described in the detailed description below, high-priority candidates monitored by the wireless device 120 are assigned to not overlap in terms of radio resources such as control-channel elements as can be seen from FIG. 14 and embodiment 6 described above, with any candidates monitored by another wireless device.

In some embodiments, e.g. according to embodiment 7 as described in the detailed description below, high-priority candidates monitored by the wireless device 120 are assigned to not overlap in terms of radio resources such as control-channel elements as can be seen from FIG. 15 and embodiment 7 described above, with high-priority candidates monitored by another wireless device.

In one embodiment the wireless device 120 receives a configuration from the radio network node 110, in another embodiment the assigning is given in the standard specification.

(2) Candidates within Multiple Search Spaces

In some embodiments, e.g. according to embodiment 4 as described in the detailed description below, a search space of higher priority is assigned to earlier time resources and a search space of lower-priority is mapped to later time resources. The terms mapped or assigned to time resources means that the candidates of the search space are assigned to radio resources occurring at a certain time.

E.g., a high-priority search space is assigned to resources in the first OFDM symbol and the lower-priority search space is assigned to resources in the second OFDM symbol.

According to a second aspect the object is achieved by example embodiments of a method performed by a radio network node 110, for assigning a control channel to a wireless terminal 120. See FIGS. 3, 4, and 6.

The wireless device 120 and the radio network node 110 operate in a wireless communications network 100. The method comprises:
Creating 601 one or multiple search spaces in the control channel to the wireless terminal 120, which search space comprises candidates, which candidates relate to control channel message candidates that the wireless device 120 will try to decode, which creating is performed by assigning in a priority order any one or more out of:
   (1) The candidates within a search space out of the one or multiple search spaces, e.g. according to embodiment 1 as described in the detailed description below and
   (2) the candidates within multiple search spaces, e.g. according to embodiment 2 as described in the detailed description below.

Sending 602 the one or multiple search spaces in the control channel to the wireless terminal 120, such as e.g. Sending 602 control information using the one or multiple search spaces in the control channel to the wireless terminal 120.

(1) and (2) listed above will be described in more details below.

Note that the assignment of priorities to candidates or search spaces may not be done by the radio network node 110, it may also be given in the related standard specification. These are two embodiments. Regardless of which the network will utilize this to transmit control information messages of high priority using candidates of high priority. If a certain control message type such as e.g. DCI format is restricted to certain candidates, the network such as the radio network node 110 will follow that restriction and transmit that type of control message only using one of those candidates.

The search space may be created by a function given by the specification that takes multiple parameters as inputs such as subframe number, the UE identity of the wireless device 120 and parameters that are semi-statically configured by the network such as e.g. the radio network node 110. Actions provided by embodiments herein are the assignment of priorities that may be given by a specification and/or be semi-statically configured by the network such as e.g. the radio network node 110 using, e.g., higher-layer signalling, and being conveyed to the wireless device 120. Another action carried out by the network such as e.g. the radio network node 110 is the transmitting of control channel messages of high priority using high-priority candidates.

(1) Candidates within a Search Space

In some embodiments, e.g. according to embodiment 3 as described in the detailed description below, candidates of higher priority are assigned to time resources earlier in the search space if the search space spans multiple time resources.

For example a high-priority candidate may be assigned to resources in the first OFDM symbol of the search space while a candidate of lower-priority is assigned to resources in the second OFDM symbol.

In some embodiments, e.g. according to embodiment 5 as described in the detailed description below, the search space may be limited. The radio network node 110 assigns such that particular DCI formats are restricted to candidates of a certain priority. E.g. such latency-critical control information may always be assigned to candidates or search spaces of high priority. Latency-critical control information may e.g. be DL assignments.

In some embodiments, e.g. according to embodiment 6 as described in the detailed description below, high-priority candidates monitored by the wireless device 120 are assigned by the radio network node 110 to not overlap in terms of radio resources such as control-channel elements as can be seen from FIG. 14 and embodiment 6 described above, with any candidates monitored by another wireless device.

In some embodiments, e.g. according to embodiment 7 as described in the detailed description below, high-priority candidates monitored by the wireless device 120 are assigned by the radio network node 110 to not overlap in terms of radio resources such as control-channel elements as can be seen from FIG. 15 and embodiment 7 described above, with high-priority candidates monitored by another wireless device.

(2) Candidates within Multiple Search Spaces

In some embodiments, e.g. according to embodiment 4 as described in the detailed description below, a search space of higher priority is assigned by the radio network node 110 or may be given in the related standard specification to earlier time resources and a search space of lower-priority is mapped to later time resources. The term mapped or assigned to time resources means that the candidates of the search space are assigned to radio resources occurring at a certain time.

E.g., a high-priority search space is assigned by the radio network node 110 to resources in the first OFDM symbol and the lower-priority search space is assigned to resources in the second OFDM symbol.

1. A method performed by a wireless device for processing a control channel from a radio network node, the wireless device and the radio network node operating in a wireless communications network, the method comprising:
monitoring one or multiple search spaces in the control channel from the radio network node, which search space comprises candidates, which candidates relate to control channel message candidates that the wireless device will try to decode, and
decoding in a priority order any one or more of:
(1) the candidates within a search space out of the one or multiple search spaces, and
(2) the candidates within multiple search spaces.

2. The method of claim 1, wherein the candidates within multiple search spaces are decoded in a priority order, and wherein a search space of higher priority is assigned to earlier time resources and a search space of lower priority is mapped to later time resources.

3. The method of claim 2, wherein a high-priority search space is assigned to resources in a first Orthogonal Frequency-Division Multiplexing, OFDM, symbol and the lower-priority search space is assigned to resources in a second OFDM symbol.

4. The method of claim 1, wherein the candidates within a search space out of the one or multiple search spaces comprise candidates of higher priority being assigned to time resources earlier in the search space if the search space spans multiple time resources.

5. The method of claim 4, wherein a high-priority candidate is assigned to resources in a first Orthogonal Frequency-Division Multiplexing, OFDM, symbol of the search space while a candidate of lower-priority may be assigned to resources in the second OFDM symbol.

6. The method of claim 1, wherein the candidates within a search space out of the one or multiple search spaces are decoded in a priority order, wherein the search space for particular Downlink Control Information, DCI, formats is limited, and wherein the DCI formats are restricted to candidates of a certain priority.

7. The method of claim 1, wherein the candidates within a search space out of the one or multiple search spaces are decoded in a priority order, and wherein high-priority candidates monitored by the wireless device are assigned to not overlap in terms of control-channel elements with any candidates monitored by another wireless device.

8. The method of claim 1, wherein the candidates within a search space out of the one or multiple search spaces are decoded in a priority order, and wherein high-priority candidates monitored by the wireless device are assigned to not overlap in terms of control-channel elements radio resources with high-priority candidates monitored by another wireless device.

9. A computer program product comprising a non-transitory computer readable medium storing a computer program comprising instructions, which when executed by a processing unit, causes the processing unit to perform the method of claim 1.

10. (canceled)

11. A method performed by a radio network node, for assigning a control channel to a wireless device, the wireless device and the radio network node operating in a wireless communications network, the method comprising:
creating one or multiple search spaces in the control channel to the wireless terminal, which search space comprises candidates, which candidates relate to control channel message candidates that the wireless device will try to decode, which creating is performed by assigning in a priority order any one or more out of: (1) the candidates within a search space out of the one or multiple search spaces, and (2) the candidates within multiple search spaces; and
sending control information using the created one or multiple search spaces in the control channel to the wireless terminal 120.

12. The method of claim 11, wherein the candidates within multiple search spaces are created by being assigned or used in a priority order, and wherein a search space of higher priority is assigned to earlier time resources and a search space of lower priority is mapped to later time resources.

13. The method of claim 12, wherein the search space of higher priority is any one out of: assigned by the radio network node 110 and is given in a related standard specification.

14. The method of claim 12, wherein a high-priority search space is assigned to resources in a first Orthogonal Frequency-Division Multiplexing, OFDM, symbol and the lower-priority search space is assigned to resources in a second OFDM symbol.

15. The method of claim 11, wherein the candidates within a search space out of the one or multiple search spaces comprise candidates of higher priority being assigned to time resources earlier in the search space if the search space spans multiple time resources.

16. The method of claim 15, wherein a high-priority candidate is assigned to resources in a first Orthogonal Frequency-Division Multiplexing, OFDM, symbol of the search space while a candidate of lower priority may be assigned to resources in the second OFDM symbol.

17. The method of claim 11, wherein the candidates within a search space out of the one or multiple search spaces are created by being assigned or used in a priority order, and wherein the search space for particular Downlink Control Information, DCI, formats is limited, and wherein the DCI formats are restricted to candidates of a certain priority.

18. The method of claim 11, wherein the candidates within a search space out of the one or multiple search spaces are created by being assigned or used in a priority order, and wherein high-priority candidates monitored by the wireless device are assigned to not overlap in terms of control-channel elements with any candidates monitored by another wireless device.

19. The method of claim 11, wherein the candidates within a search space out of the one or multiple search spaces are created by being assigned or used in a priority order, and wherein high-priority candidates monitored by the wireless device are assigned to not overlap in terms of control-channel elements with high-priority candidates monitored by another wireless device.

20. A computer program product comprising a non-transitory computer readable medium storing a computer program comprising instructions, which when executed by a processing unit, causes the processing unit to perform the method of claim 11.

21. (canceled)

22. A wireless device for processing a control channel from a radio network node, the wireless device and the radio network node are operable in a wireless communications network, the wireless device being configured to:
monitor one or multiple search spaces in the control channel from the radio network node which search space comprises candidates, which candidates relate to control channel message candidates that the wireless device will try to decode, and
decode in a priority order any one or more out of:
(1) the candidates within a search space out of the one or multiple search spaces, and
(2) the candidates within multiple search spaces.

23. The wireless device of claim 22, wherein the candidates within multiple search spaces are arranged to be decoded in a priority order, and wherein a search space of higher priority is arranged to be assigned to earlier time resources and a search space of lower priority is mapped to later time resources.

24. The wireless device of claim 23, wherein a high-priority search space is arranged to be assigned to resources in a first Orthogonal Frequency-Division Multiplexing, OFDM, symbol and the lower-priority search space is assigned to resources in a second OFDM symbol.

25. The wireless device of claim 22, wherein the candidates within a search space out of the one or multiple search spaces comprise candidates of higher priority arranged to be assigned to time resources earlier in the search space if the search space spans multiple time resources.

26. The wireless device of claim 25, wherein a high-priority candidate is arranged to be assigned to resources in a first Orthogonal Frequency-Division Multiplexing, OFDM, symbol of the search space while a candidate of lower priority may be assigned to resources in the second OFDM symbol.

27. The wireless device of claim 22, wherein the candidates within a search space out of the one or multiple search spaces are arranged to be decoded in a priority order, wherein the search space for particular Downlink Control Information, DCI, formats is limited, and wherein the wireless device 120 is configured to assume that particular DCI formats are restricted to candidates of a certain priority.

28. The wireless device of claim 22, wherein the candidates within a search space out of the one or multiple search spaces are arranged to be decoded in a priority order, and wherein high-priority candidates monitored by the wireless device are assigned to not overlap in terms of control-channel elements with any candidates monitored by another wireless device.

29. The wireless device of claim 22, wherein the candidates within a search space out of the one or multiple search spaces are arranged to be decoded in a priority order, and wherein high-priority candidates monitored by the wireless device are arranged to be assigned to not overlap in terms of control-channel elements with high-priority candidates monitored by another wireless device.

30. A radio network node for assigning a control channel to a wireless device, the wireless device and the radio network node are operable in a wireless communications network, the radio network node being configured to:
create one or multiple search spaces in the control channel to the wireless terminal, which search space is arranged to comprise candidates, which candidates relate to control channel message candidates that the wireless device will try to decode, wherein the radio network node is configured to perform the creating by assigning in a priority order any one or more out of:
(1) the candidates within a search space out of the one or multiple search spaces, and
(2) the candidates within multiple search spaces, and
wherein the radio network node is configured to send control information using created one or multiple search spaces in the control channel to the wireless terminal 120.

31. The radio network node of claim 30, wherein the candidates within multiple search spaces are arranged to be created by being assigned or used in a priority order, and wherein the radio network node is configured to perform the creating by assigning a search space of higher priority to earlier time resources and a search space of lower priority to later time resources.

32. The radio network node of claim 31, wherein the search space of higher priority is any one out of: assigned by the radio network node 110 and is given in a related standard specification.

33. The radio network node of claim 30, wherein a high-priority search space is arranged to be assigned to resources in a first Orthogonal Frequency-Division Multiplexing, OFDM, symbol and the lower-priority search space is assigned to resources in a second OFDM symbol.

34. The radio network node of claim 30, wherein the radio network node is configured to perform the creating by assigning candidates of higher priority to time resources earlier in the search space if the search space spans multiple time resources.

35. The radio network node of claim 34, wherein a high-priority candidate is arranged to be assigned to resources in a first Orthogonal Frequency-Division Multiplexing, OFDM, symbol of the search space while a candidate of lower priority may be assigned to resources in the second OFDM symbol.

36. The radio network node of claim 30, wherein the candidates within a search space out of the one or multiple search spaces are arranged to be created by being assigned or used in a priority order, and wherein the search space for particular Downlink Control Information, DCI, formats is arranged to be limited, and wherein the radio network node 110 is configured to perform the creating by assigning such that particular DCI formats are restricted to candidates of a certain priority.

37. The radio network node of claim 30, wherein the candidates within a search space out of the one or multiple search spaces are arranged to be created by being assigned or used in a priority order, and wherein the radio network node 110 is configured to perform the creating by assigning high-priority candidates to be monitored by the wireless device 120 to not overlap in terms of control-channel elements with any candidates to be monitored by another wireless device.

38. The radio network node of claim 30, wherein the candidates within a search space out of the one or multiple search spaces are arranged to be created by being assigned or used in a priority order, and wherein the radio network node 110 is configured to perform the creating by assigning high-priority candidates to be monitored by the wireless device 120 to not overlap in terms of control-channel elements with high-priority candidates to be monitored by another wireless device.
